(19) United States
(12) Patent Application Publication
(10) Pub. No.: US 2014/0320340 A1
(43) Pub. Date: Oct. 30, 2014

(54) INDOOR LOCALIZATION USING ANALOG OFF-AIR ACCESS UNITS

(71) Applicant: DALI SYSTEMS CO. LTD., George Town (KY)

(72) Inventor: Shawn Patrick Stapleton, Burnaby (CA)

(73) Assignee: DALI SYSTEMS CO. LTD., George Town (KY)

(21) Appl. No.: 14/183,297

(22) Filed: Feb. 18, 2014

Related U.S. Application Data
(60) Provisional application No. 61/767,731, filed on Feb. 21, 2013.

(51) Int. Cl. G01S 19/11; G01S 5/14

(52) U.S. Cl. CPC G01S 19/11; G01S 5/14
USPC 342/357.48; 342/464

(57) ABSTRACT

A system for indoor localization using GPS signals in a Distributed Antenna System includes a plurality of Off-Air Access Units (OAAUs). Each of the plurality of OAAUs is operable to receive a GPS signal from at least one of a plurality of GPS satellites and operable to route signals optically to one or more HUBs. The system also includes a plurality of remote units (RUs) located at a Remote location. The plurality of RUs are operable to receive signals from a plurality of local HUBs. The system further includes an algorithm to delay each individual GPS satellite signal to provide indoor localization at each of the plurality of RUs.

### CROSS-REFERENCES TO RELATED APPLICATIONS

This application claims priority to U.S. Provisional Patent Application No. 61/767,731, filed on Feb. 21, 2013, entitled “Indoor Localization Using Analog Off-Air Access Units,” the disclosure of which is hereby incorporated by reference in its entirety for all purposes.

### BACKGROUND OF THE INVENTION

Global Positioning System (GPS) technologies, initially utilized by military organizations, including the U.S. Department of Defense, have now achieved widespread use in civilian applications. The widespread availability of GPS has enabled the provision of many location-based services, providing location information for mobile devices.

Although GPS provides high accuracy in positioning when outdoors, the GPS signal may not be received with sufficient strength and from enough satellites when a user is inside a building or structure. An indoor positioning system (IPS) is a network of devices used to locate objects or people inside a building. Currently, no standard for an IPS has been adopted in a widespread manner, adversely impacting deployment.

An IPS typically relies on anchors with known positions rather than relying on satellites, since satellite signals are not typically available at indoor positions as a result of signal attenuation resulting from roofs and other building structures. Despite the progress made in IPS design and implementation, there is a need in the art for improved methods and systems related to indoor localization.

### SUMMARY OF THE INVENTION

The present invention generally relates to wireless communication systems employing Distributed Antenna Systems (DAS) as part of a distributed wireless network. More specifically, the present invention relates to a DAS utilizing a analog Off-Air Access Unit (OAAU). In a particular embodiment, the present invention has been applied to receive GPS signals at the OAAUs that can be configured in a star configuration or a daisy chained configuration. The methods and systems described herein are applicable to a variety of communications systems including systems utilizing various communications standards.

Global Positioning System (GPS) has received widespread use in many applications such as traffic management, navigation, medical emergency services as well as location based services for handsets. Although GPS positioning is prevalent in outdoor applications, indoor localization using GPS is not common because of the large signal attenuation caused by the building walls. Most indoor positioning solutions require unique infrastructure that is complicated and expensive to deploy. The proposed indoor positioning architecture uses the existing GPS Satellite infrastructure and can be used with standard handsets that contain GPS receivers. In this description, reference is made to the GPS satellite system and GPS is discussed herein as an exemplary satellite navigation system, however, other systems, including GLONASS (Russian), Galileo (Europe), QZSS (Japanese), and BeiDou (Chinese) are included within the scope of the present invention and should be understood to fall under the umbrella of systems collectively referred to as GPS herein.

A distributed antenna system (DAS) provides an efficient means of distributing signals over a given geographic area. The DAS network comprises one or more HUBs that function as the interface between the Off-Air Access Units (OAAU) and the remote units (RUs). The HUBs can be collocated with the Off-Air Access Units (OAAU). Under certain embodiments the Off-Air Access Units may not be collocated with the HUBs. Off-Air Access Units can be used to relay GPS Satellite signals to one or more HUBs. Under certain embodiments the Off-Air Access Units may relay the GPS signals directly to one or more Remote Units (RUs). One or more Off-Air Access Units can be used to communicate with one or more Satellites. The Off-Air Access Units relay the RF GPS signals between the Satellite and the coverage area.

According to an embodiment of the present invention, a system for indoor localization using GPS signals in a Distributed Antenna System is provided. The system includes a plurality of Off-Air Access Units (OAAUs), each of the plurality of OAAUs being operable to receive a GPS signal from at least one of a plurality of GPS satellites and operable to route signals optically to one or more local HUBs. The system also includes a plurality of remote units (RUs) located at Remote locations. The plurality of RUs are operable to receive signals from one or more of the plurality of local HUBs. The system further includes a delay unit operable to delay GPS satellite signal to provide indoor localization at each of the plurality of RUs.

According to another embodiment of the present invention, a system for indoor localization using GPS signals in a Distributed Antenna System is provided. The system includes a plurality of Off-Air Access Units (OAAUs). Each of the plurality of OAAUs is connected together via a daisy chain configuration, receives a GPS signal from at least one of a plurality of GPS satellites, and is operable to route signals optically to one or more HUBs. The system also includes a plurality of remote units (RUs) located at one or more Remote locations. The plurality of RUs are operable to receive signals from a plurality of local HUBs. The system further includes a delay block operable to delay the GPS signal.

According to an alternative embodiment of the present invention, a system for indoor localization using GPS signals in a Distributed Antenna System is provided. The system includes a plurality of Off-Air Access Units (OAAUs), receiving a GPS signal from at least one of a plurality of GPS satellites, and operable to route signals optically to one or more HUBs. The system also includes a plurality of remote units (RUs) located at one or more Remote locations. The plurality of RUs are operable to receive signals from one or more of a plurality of local HUBs. The system further includes a de-multiplexer to extract one of the GPS satellite signals and time delay it at each of the plurality of RUs and an algorithm for determining the delay at each of the plurality of RUs to provide indoor localization.

According to a specific embodiment of the present invention, a system for indoor localization using GPS signals in a Distributed Antenna System is provided. The system includes a plurality of Multiple Input Off-Air Access Units (OAAUs), each receiving a GPS signal from at least one of the plurality of GPS satellites, and operable to route signals optically to one or more HUBs. The system also includes a plurality of remote units (RUs) located at a Remote location. The plurality of RUs are operable to receive signals from a plurality of local HUBs. The system also includes an algorithm to delay each individual GPS satellite signal for providing indoor localization at each of the plurality of RUs.

According to another specific embodiment of the present invention, a system for indoor localization using GPS signals in a Distributed Antenna System is provided. The system includes a plurality of Off-Air Access Units (OAAUs), each receiving at least one GPS signal from at least one of a plurality of GPS satellites, and operable to route signals directly to one or more remote units.

Numerous benefits are achieved by way of the present invention over conventional techniques. Traditionally, an Off-Air GPS Repeater communicates with the satellite via a wireless RF signal and communicates with the coverage area via a wireless RF signal. Off-Air GPS repeaters broadcast the GPS Satellite signal indoors, which provides the GPS Handset receiver with the position of the Off-Air Repeater. No additional intelligence is used in some embodiments to provide any positional information for the location of the indoor user relative to the Off-Air Repeater. An Off-Air Access Unit (OAAU) relays the GPS signals to a HUB via an optical cable. The GPS signals from the Off-Air Access Unit are transported over an optical cable to one or more HUBs or directly to one or more Remote Units (RU). Transporting the Off-Air Access Unit signals optically provides an additional benefit of enabling wavelength multiplexing of multiple GPS signals from multiple Off-Air Access Units. Additionally, embodiments enable the routing of the Off-Air Access Unit signals to one or more remote locations. Utilizing multiple GPS signals from multiple OAAUs can provide enhanced indoor localization accuracy. These and other embodiments of the invention along with many of its advantages and features are described in more detail in conjunction with the text below and attached figures.

### BRIEF DESCRIPTION OF THE DRAWINGS

FIG. 1 is a block diagram according to one embodiment of the invention showing the basic structure and an example of the transport routing based on having a 3 GPS satellites with 3 HUBs at a local location, 3 Off-Air Access Units (OAAUs) at a local location and Remote Units (RUs) at a remote location. In this embodiment, 3 OAAUs are connected to a HUB at the local location.

FIG. 2A is a block diagram according to one embodiment of the invention showing the basic structure and an example of the transport routing based on having a 3 Satellites with 3 HUBs at a local location, 3 OAAUs daisy chained together at a local location and optical interfaces to RUs at the remote locations.

FIG. 2B shows the data transport structure and the HUB interfaces whereby the various Satellite GPS signals are wavelength-multiplexed onto a fiber.

FIG. 2C shows one embodiment of the HUB whereby the input interface from the OAAUs is the GPS RF signals and the output interface of the HUB is an optical signal.

FIG. 2D shows a block diagram of an Off-Air Access Unit that transports the GPS RF signal to the HUB via an RF cable.

FIG. 2E shows a block diagram of an Off-Air Access Unit that translates the RF GPS signal to an optical signal for transport to the HUB.

FIG. 2F shows a block diagram of an Off-Air Access Unit that translates the RF GPS signal to an Intermediate Frequency (IF) signal before it is transported over an RF cable to the HUB.

FIG. 3 is a block diagram according to one embodiment of the invention showing the basic structure and an example of the transport routing based on having multiple OAAUs at local locations with multiple HUBs at a local location, and multiple Remote Units (RUs) at a remote location and optical interfaces to the Remotes.

FIG. 4 is a block diagram illustrating one embodiment of a Remote Unit, which contains an input optical interface, analog time delay blocks, frequency translators and a RF combiner.

FIG. 5A is a diagram illustrating the data flow structure between the Off-Air Access Unit (OAAU) and the HUB or another RU. The transport between the OAAU and the HUB is at RF via an RF cable. The transport between the HUB and the RUs is at IF over a RF cable.

FIG. 5B is a diagram illustrating the data flow structure between the Off-Air Access Unit (OAAU) and the HUB or another RU. The transport between the OAAU and the HUB is at IF via an RF cable. The transport between the HUB and the RUs is at IF over a RF cable.

FIG. 6 is a diagram illustrating the data flow structure between the Off-Air Access Unit (OAAU) and the HUB or another RU. The transport between the OAAU and the HUB is at an optical wavelength via an optical cable. The transport between the HUB and the RUs is at an optical wavelength via an optical cable.

FIG. 7 is a block diagram according to one embodiment of the invention showing the basic structure and an example of the transport routing based on having multiple OAAUs at local locations with multiple Remote Units (RUs) at a remote location and optical interfaces to the Remotes.

FIG. 8 is a block diagram according to one embodiment of the invention showing the basic structure and an example of the transport routing based on a single OAAUs with 3 receivers at the local location with multiple HUBs at a local location, and multiple Remote Units (RUs) at a remote location and optical interfaces to the Remotes.

FIG. 9 is a conceptual building layout according to one embodiment of the invention showing 2 OAAUs receiving the GPS signals from a subset of Satellites and transporting those signals to the Remote Units (RU) via optical cables. The remote signals at the RUs are broadcast over the antennas and received by the users GPS receiver.

FIG. 10 is a block diagram according to one embodiment of the invention showing the basic structure whereby the OAAU GPS signals from the individual Satellites are delayed relative to one another and then combined.

FIG. 11 is a block diagram according to one embodiment of the invention showing the basic structure whereby one of the OAAU GPS signals is delayed and then transmitted at one of more RUs. The GPS signals for the individual satellites is transmitted on separate RUs for the objective are replicating the satellite configuration indoors.

FIG. 12 is a block diagram according to one embodiment of the invention showing the basic structure whereby the OAAU GPS signals are delayed relative to one another and then combined. Each RU is fed a distinct combination of Satellite GPS signals.

### DETAILED DESCRIPTION OF SPECIFIC EMBODIMENTS

A distributed antenna system (DAS) provides an efficient means of transporting signals between local units and remote units. The DAS network comprises one or more HUBs that function as the interface between the Off-Air Access Units (OAAU) and the remote units (RUs). The HUBs can be collocated with the Off-Air Access Units (OAAU). The RUs can be daisy chained together and/or placed in a star configuration and provide coverage for a given geographical area. The RUs are typically connected with the HUBs by employing an optical fiber link. This approach facilitates transport of the RF signals from the Off-Air Access Units (OAAU) to a remote location or area served by the RUs.

An Off-Air Access Units communicate with one of more GPS Satellites over the air. Off-Air Access Units are convenient for relaying GPS signals between locations that are not well covered by the GPS Satellite itself. A typical Off-Air Access Unit receives the Downlink RF GPS signal from a Satellite, amplifiers and filters the RF signal and transports it to a RU for a given coverage area. Each Off-Air Access Unit utilizes a directional antenna to communicate with a distinct subset of GPS Satellites. A minimum of 3 GPS Satellites need to be received in order to triangulate of the receivers' position. The relative time-delays between the 3 GPS Satellites provide a means of identifying the 2D position of the receiver. 4 GPS Satellite signals will provide 3D localization of the receiver. Directional antennas are used at the Off-Air Access Units in order to separate the 3 or more Satellite signals. Each GPS Satellite signal will be transported to the HUB and sent to the remote units RUs. It is assumed that the RUs position is known a-priori. The RU's will receive the independent GPS satellite signals, which are independently time-delayed, by a user, in order to replicate the GPS position of the RUs. The GPS positional information of each RU can be determined from a 3D map of the given indoor venue. One embodiment of this invention is that a GPS receiver can be incorporated in both the RU as well as the Off-Air Access Units. The absolute GPS position of the RUs can be obtained be using the Off-Air Access unit GPS position information and then adjusting it to the 3D position offset inside the venue, i.e., 4^{th} floor, 30 m North, 10 m West. Locating a GPS receiver at the RU will provide a feedback mechanism of insuring the accuracy of the user-established time-delays.

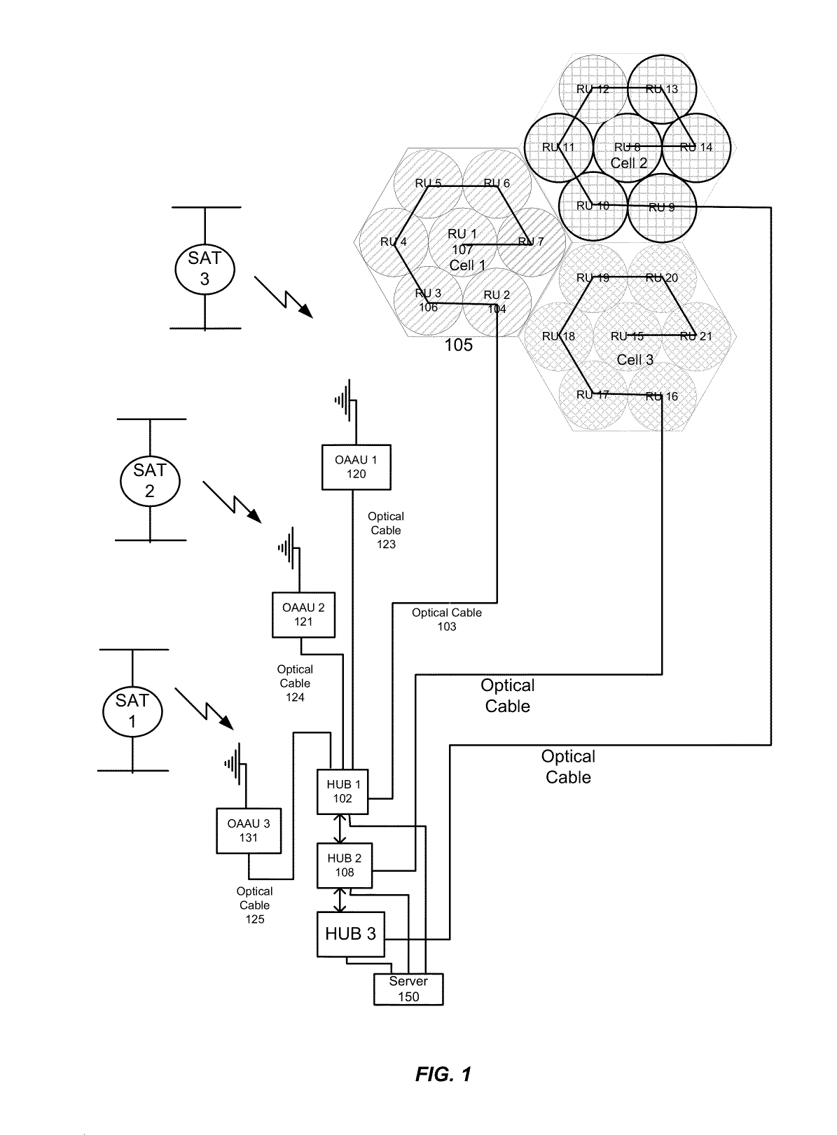

FIG. 1 illustrates a DAS network architecture according to an embodiment of the present invention and provides an example of a transport scenario between 3 GPS Satellites, multiple Off-Air Access Units (OAAUs), multiple local HUBs, and multiple RUs. GPS Satellites 1,2 and 3 are connected to OAAU 1 (120), OAAU 2 (121), and OAAU 3 (131), respectively, by wireless links in the illustrated embodiment. HUBs 1 (102), (108) and HUB 3 route the Off-Air Access Unit signals to the various RUs. Each of the local HUBs is connected to server (150). In this embodiment, the OAAUs are connected in a star configuration with HUB (102) using optical cables.

The DAS network can include a plurality of OAAUs, HUBs and RUs. The HUB communicates with the network of RUs and the HUB sends commands and receives information from the RUs. The HUBs include physical nodes that accept and deliver RF signals and optical nodes that accept and deliver optical signals. A HUB can include an internal server or an external server. The server is used to archive information in a database, store the DAS network configuration information, and perform various data related processing.

Additionally, the OAAU communicates with the HUB. The OAAU receives commands from the HUB and delivers information to the HUB. The OAAUs include physical nodes that accept GPS RF signals and optical nodes that transport optical signals.

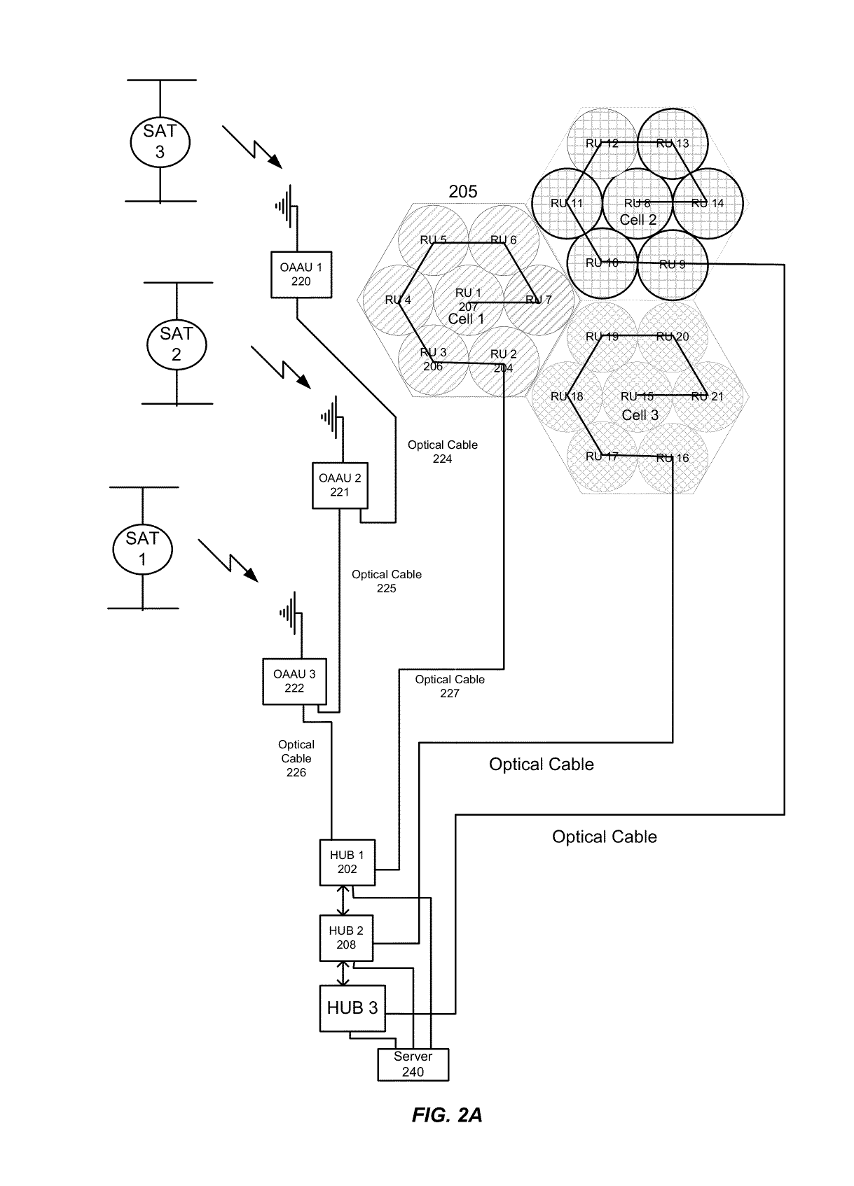

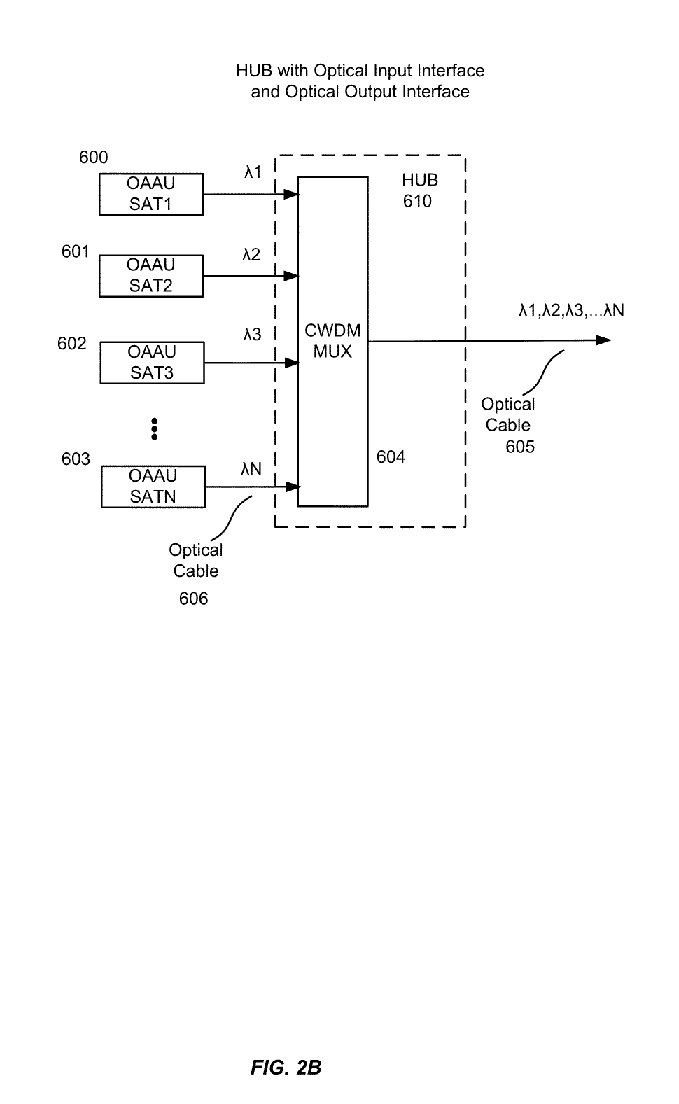

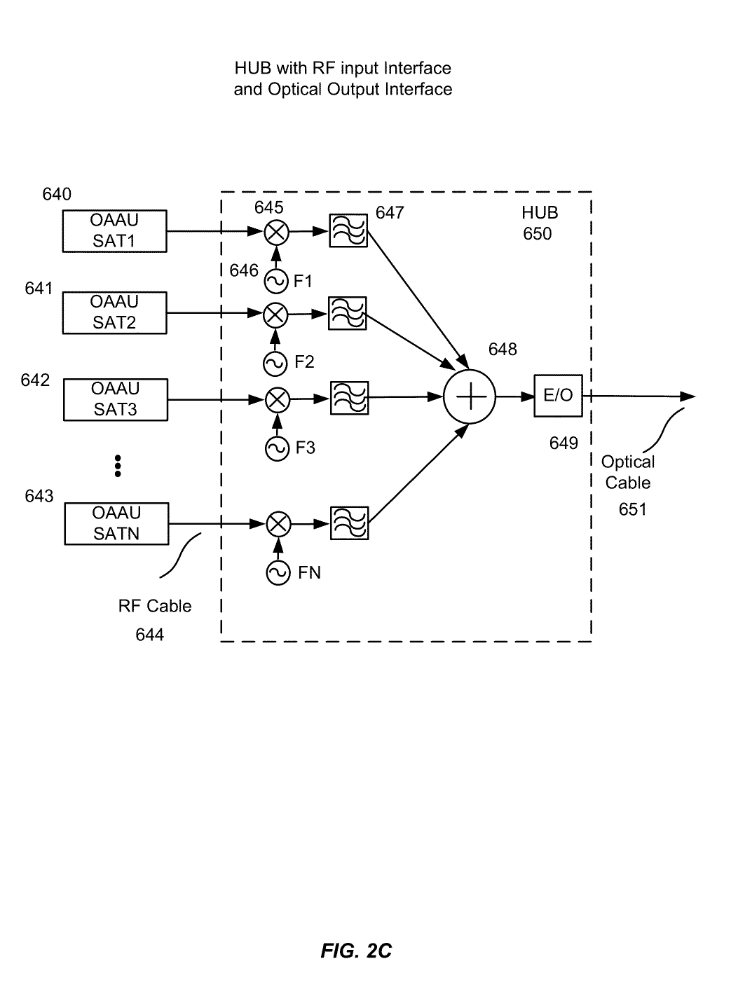

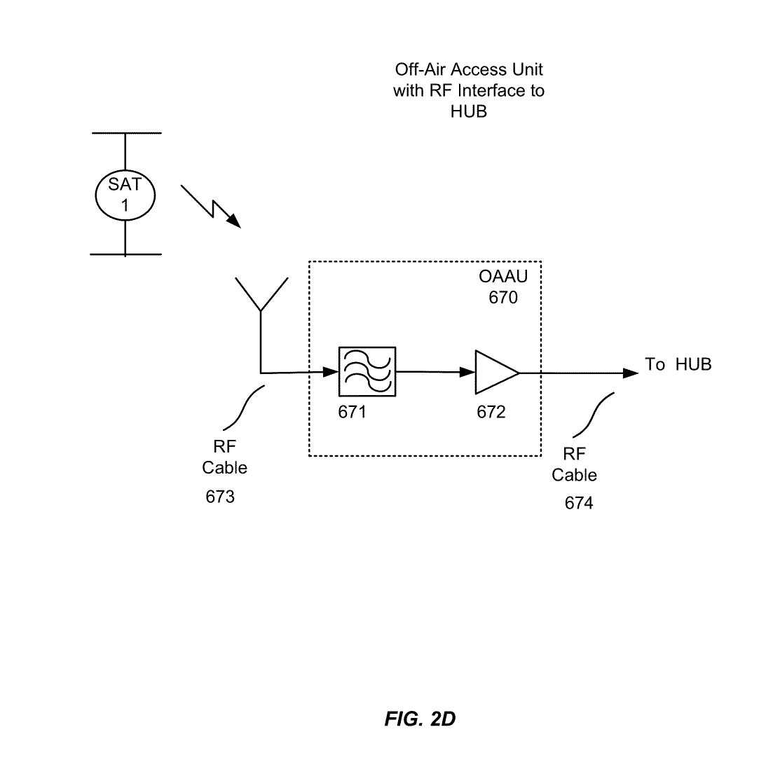

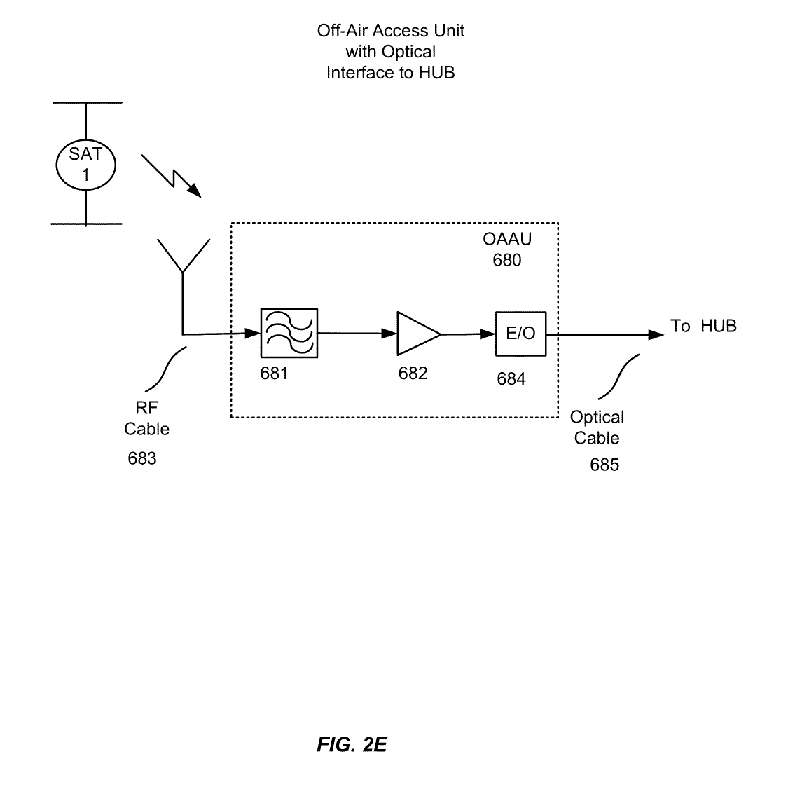

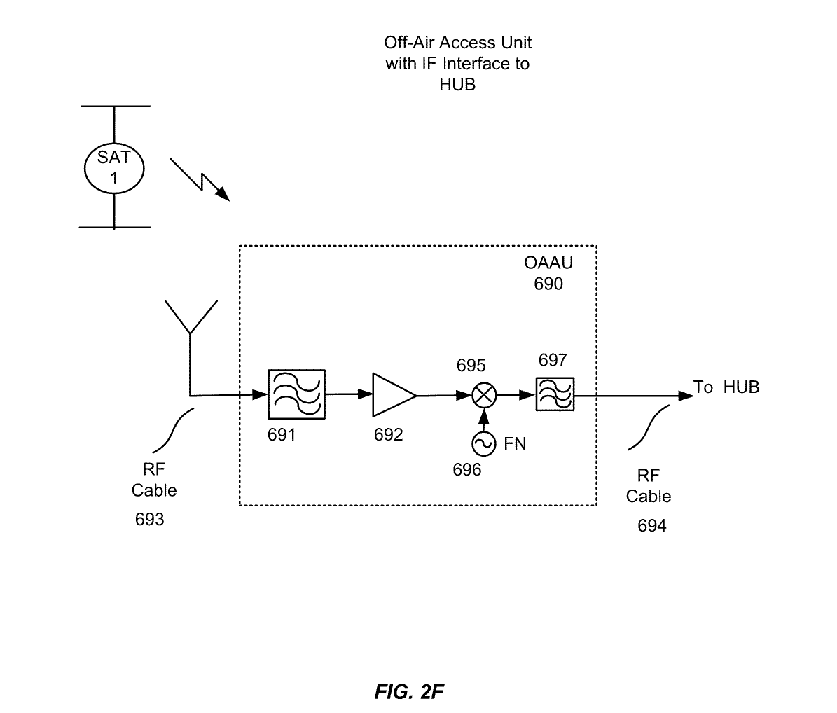

As shown in FIG. 2A, the individual GPS signals from Satellites SAT 1, SAT 3 and SAT 4 are transported to a daisy-chained network of OAAUs. FIG. 2A demonstrates how three independent Satellites, each Satellite communicating with an independent OAAU, provide input into a single HUB (202). A server (240) is utilized to control the routing function provided in the DAS network. Referring to FIG. 2A and by way of example, HUB 1 (202) receives downlink GPS signals from the daisy-chained network of OAAUs (220, 221, 222). OAAU 1 (220) translates the RF signals to optical signals for the downlink. The optical fiber cable (224) transports the SAT 1 signals between OAAU 1 (220) and OAAU 2 (221). The optical signals from OAAU 1 (220) and OAAU 2 (221) are multiplexed on optical fiber (225). The other OAAUs in the daisy chain are involved in passing the optical signals onward to HUB 1 (202). HUB 1 (202) HUB 2 and HUB 3 transport the optical signals to and from the network of RUs.

FIG. 2B shows one embodiment of the present invention of a HUB, whereby the HUB receives distinct optical wavelengths from each OAAU, optically multiplexes them and then transports them to the remote units (RUs) via one or more optical cables (605). The optical multiplexer is a Coarse Wavelength Division Multiplexer (CWDM) (604).

FIG. 2C shows one embodiment of the present invention of a HUB, whereby the HUB receives the GPS RF signals from the OAAUs, translates each OAAU signal to a distinct IF frequency, combines the IF signals, transforms the electrical signal to an optical signal and then transports them optically to the remote units (RUs). HUB (650) accepts the RF input signals via RF cables (644) and then proceeds to frequency translate each OAAU RF signal to a distinct IF. Mixer (645), Oscillator (646) and filter (647) are used to translate the RF GPS signal to a distinct IF frequency. Combiner (648) sums the IF signals followed by an electrical to optical converter (649). The signal is delivered to one or more RUs via the optical cable (651).

FIG. 2D is one embodiment of a Off-Air Access Unit, whereby the GPS RF signal received form the Satellite is filtered (671) and amplified (672) before it is transported to the HUB via an RF cable.

FIG. 2E is one embodiment of an Off-Air Access Unit, whereby the GPS RF signal is filtered (681), amplified (682) and then translated to an optical signal via the Electrical to Optical (E/O) converter (684). The OAAU can select a unique wavelength of the E/O converter. The optical signal is transported to one or more HUBs via the optical cable (685).

FIG. 2F is one embodiment of an Off-Air Access Unit, whereby the GPS RF signal is filtered (691), amplified (692) and then frequency translated to an IF frequency. The frequency translator is comprised of a mixer (695), oscillator (696) and a filter (697). The IF signal is sent via the RF cable (694) to one or more HUBs.

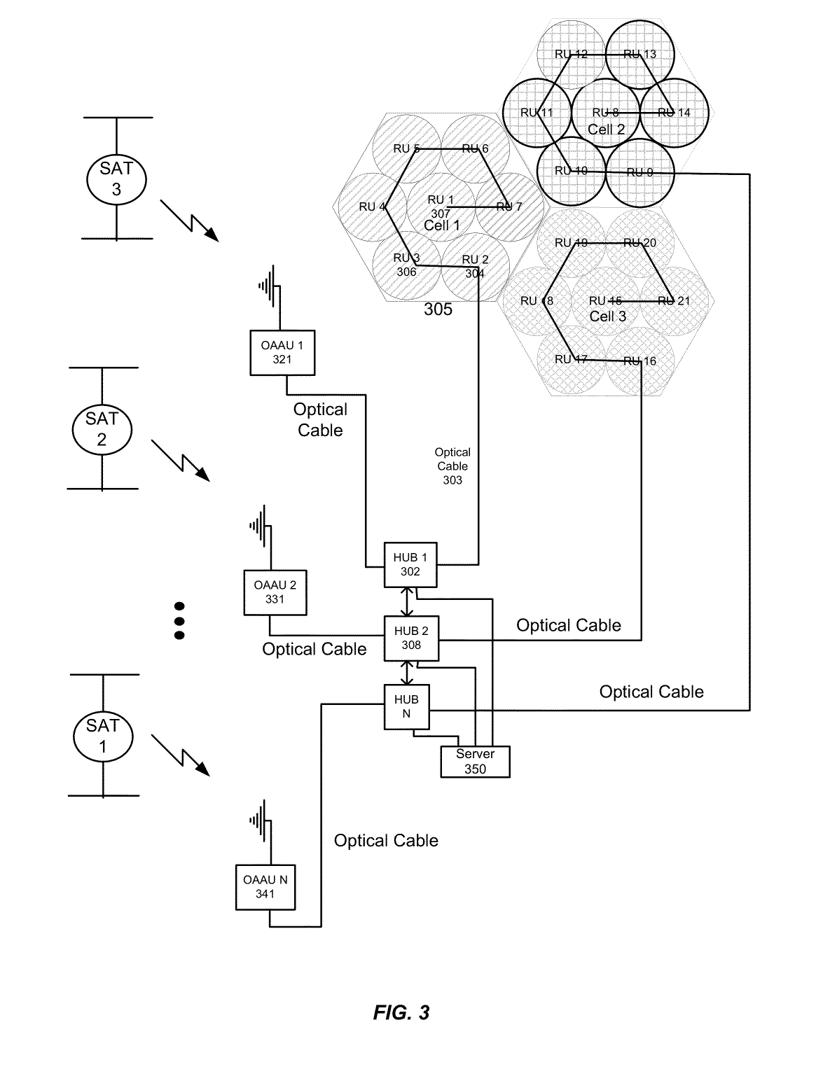

FIG. 3 depicts a DAS system employing multiple Off-Air Access Units (OAAUs) at the local location and multiple Remote Units (RUs) at the remote location. In accordance with the present invention, each RU provides unique information associated with each RU, which uniquely identifies the signal received by a particular Remote Unit. In this embodiment, the individual OAAUs are independently connected to HUBs. Another embodiment of the present invention is the use of RF connections between the OAAUs and the HUBs. In this alternative embodiment the OAAU will receive the RF signals from the GPS Satellite and transport the RF signal to a HUB using an RF cable.

The servers illustrated herein, for example, server (350) provide unique functionality in the systems described herein. The following discussion related to server (350) may also be applicable to other servers discussed herein an illustrated in the figures. The server (350) can store configuration information, for example, if the system gets powered down or one RU or OAAU goes off-line and then you power up the system, it will typically need to be reconfigured. The server (350) can store the information used in reconfiguring the system and/or the RUs, OAAUs or HUBs. B

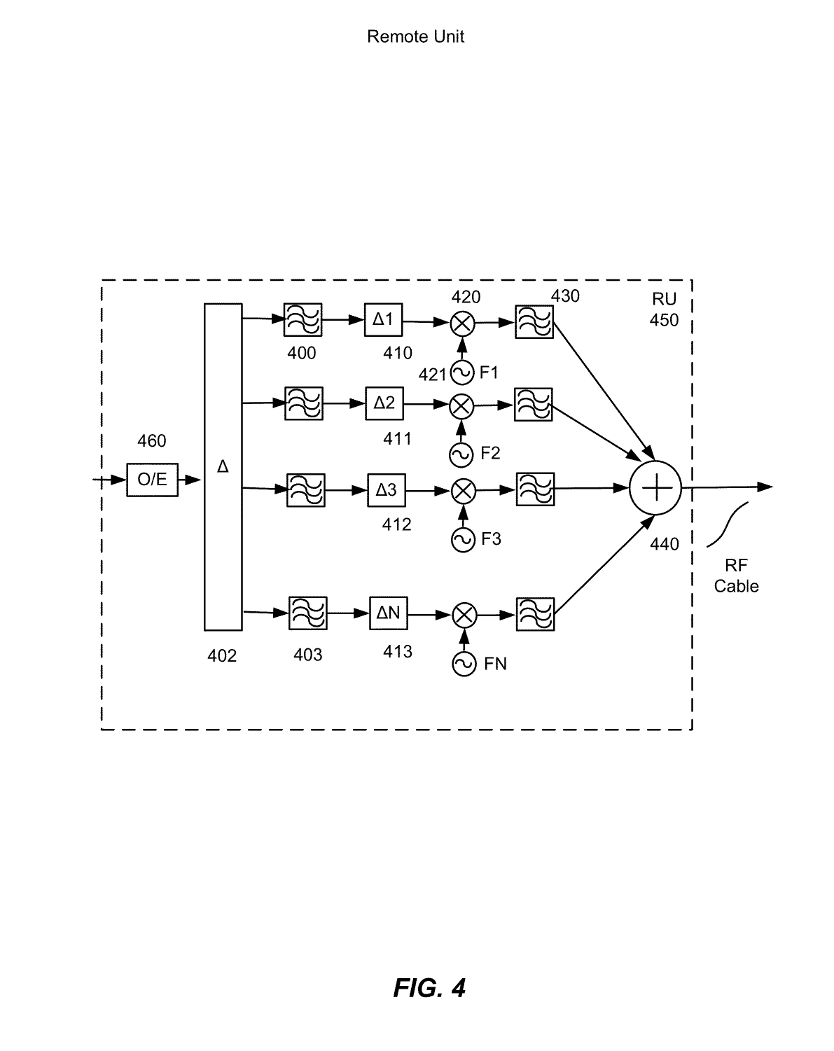

FIG. 4 shows one embodiment of a remote unit (RU), whereby the optical signal from the HUB is translated to an electrical signal via the E/O (460) converter. The electrical signal is then split amongst multiple frequency translation branches. Each branch represents a distinct Satellite GPS signal. A distinct analog delay block (410) is used for each GPS Satellite signal. In this embodiment the delay blocks are at the Intermediate Frequencies. The IF signal of each branch is then frequency translated to RF using a combination of a mixer (420), oscillator (421), and filter (430). The output of the frequency translation branches is then summed before deliver to the RF cable and subsequently transmitted. The delay blocks are used to establish the positional information of the remote unit. Each Satellite GPS signal is delayed by a respective value in order to create the GPS position that will be realized when each of the Satellite signals is summed.

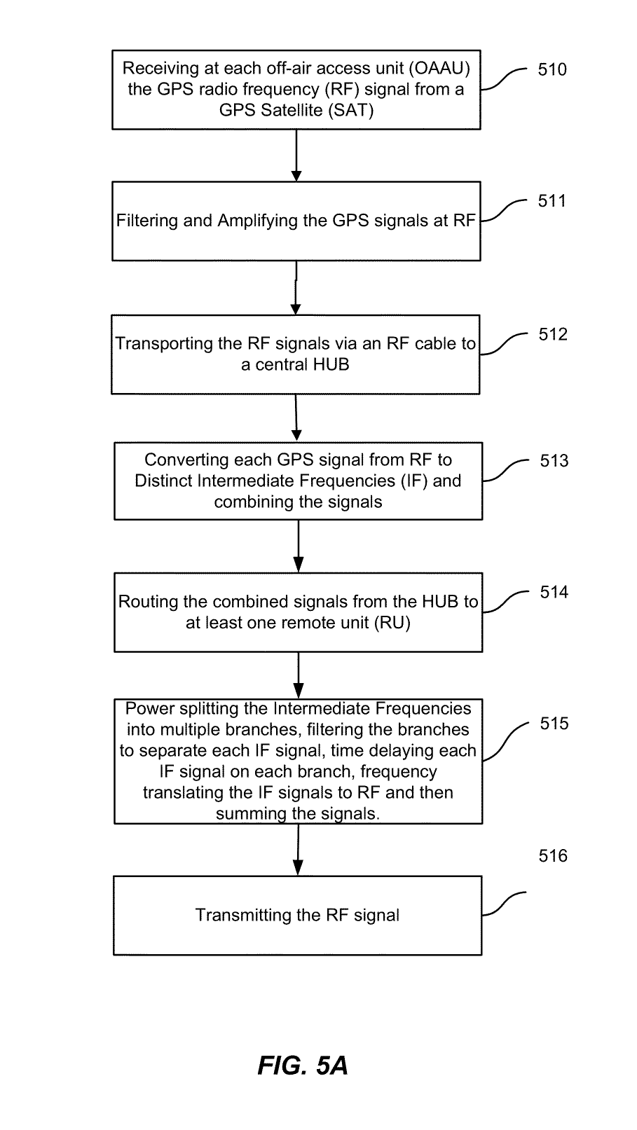

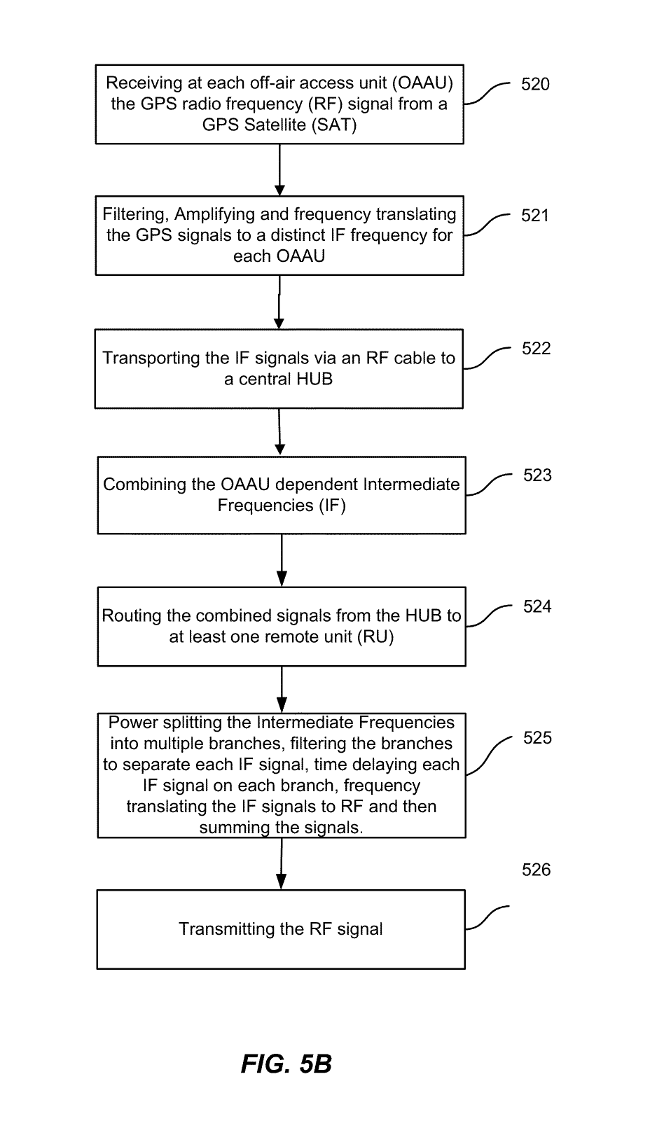

FIG. 5A shows an embodiment of the flowchart for the routing of the GPS signals from the various Satellites to each RU. In this embodiment, the distinct GPS signals are transported via RF frequencies between the OAAU and the HUB. As shown in block (515), the IF GPS signals from the respective Satellites are time delay offset to replicate the GPS position of the respective RU. The RU then broadcasts the GPS signal for detection by the users equipment. In another embodiment of the present invention, the IF frequencies can be translated to RF and then time delayed at RF before the branches are summed.

FIG. 5B shows an embodiment of the flowchart for the routing of the GPS signals from the various Satellites to each RU. In this embodiment, the distinct GPS signals are transported via distinct IF frequencies between the OAAU and the RUs. As shown in block (525), the IF GPS signals from the respective Satellites are time delay offset to replicate the GPS position of the respective RU. The RU then broadcasts the GPS signal for detection by the users equipment.

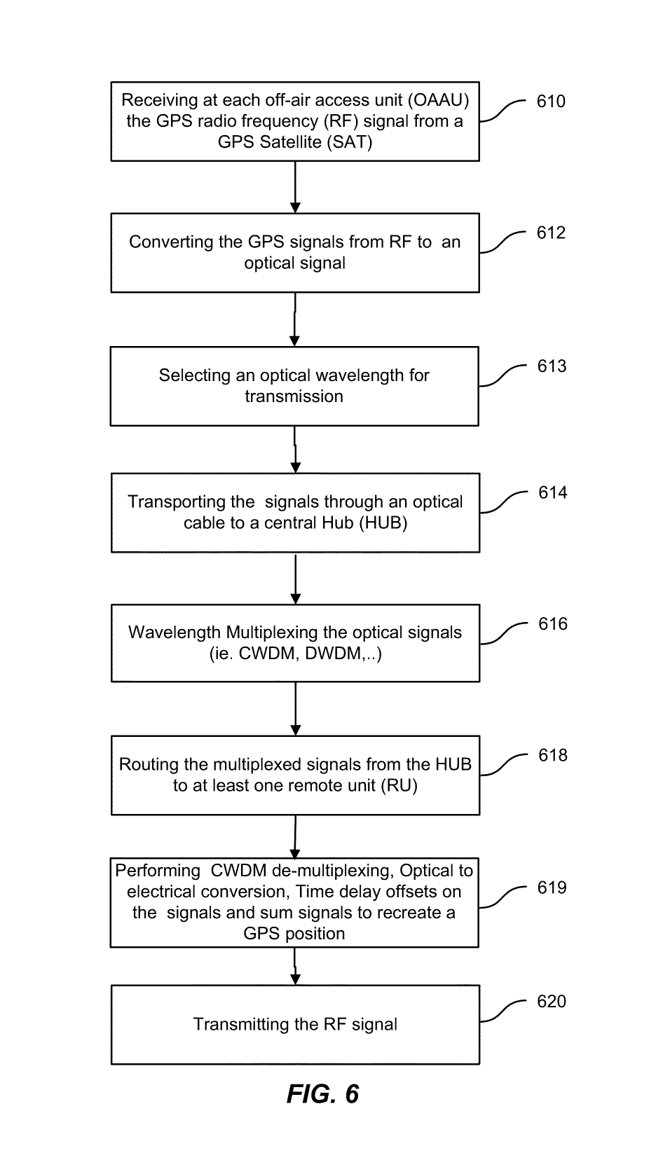

FIG. 6 shows an embodiment of the flowchart for the routing of the GPS signals from the various Satellites to each RU. In this embodiment, the distinct GPS signals are transported via distinct optical wavelengths. As shown in block (619), the wavelength multiplexed GPS signals from the respective Satellites are time delay offset to replicate the GPS position of the respective RU. The RU then broadcasts the GPS signal for detection by the users equipment.

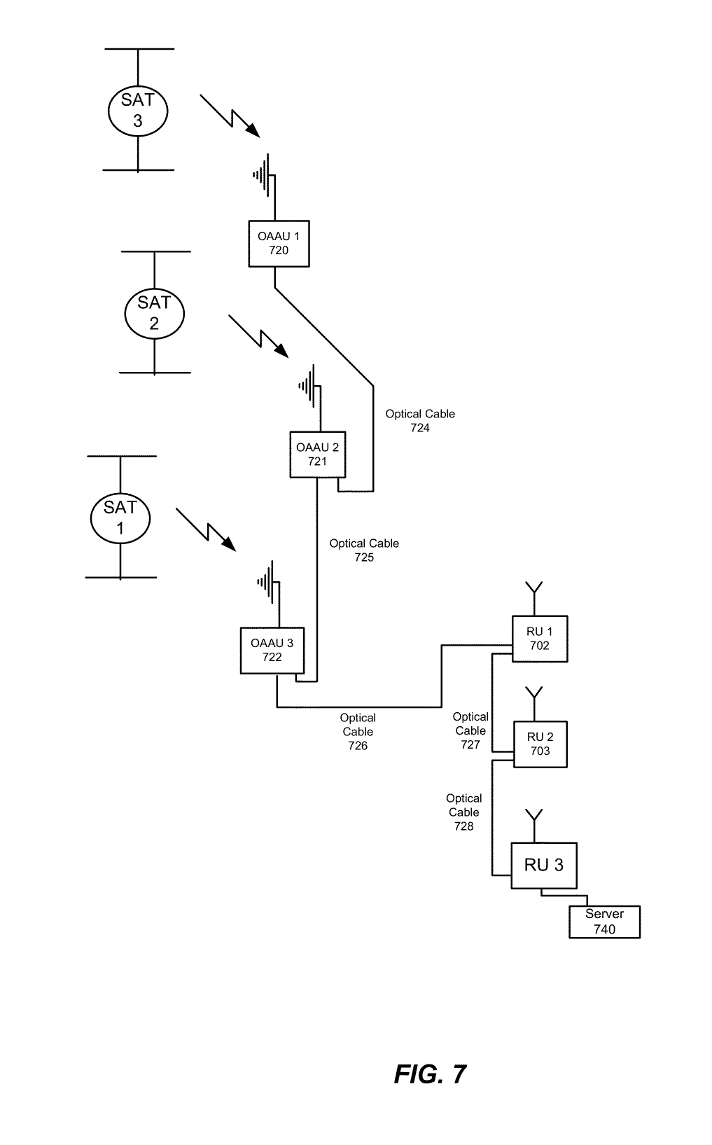

As shown in FIG. 7, the individual GPS signals from Satellites SAT 1, SAT 3 and SAT 4 are transported to a daisy-chained network of OAAUs. FIG. 7 demonstrates how three independent Satellites, each Satellite communicating with an independent OAAU, provide input into a single RU (702). A server (740) is utilized to control the routing function provided in the DAS network. Referring to FIG. 7 and by way of example, RU 1 (702) receives downlink GPS signals from the daisy-chained network of OAAUs (720, 721, 722). OAAU 1 (720) translates the RF signals to optical signals for the downlink. The optical fiber cable (724) transports the SAT 1 signals between OAAU 1 (720) and OAAU 2 (721). The optical signals from OAAU 1 (720) and OAAU 2 (721) are multiplexed on optical fiber (725). The other OAAUs in the daisy chain are involved in passing the optical signals onward to RU 1 (702). RU 1 (702) RU 2 and RU 3 transport the optical signals to and from the network of DRUs in a daisy chain configuration.

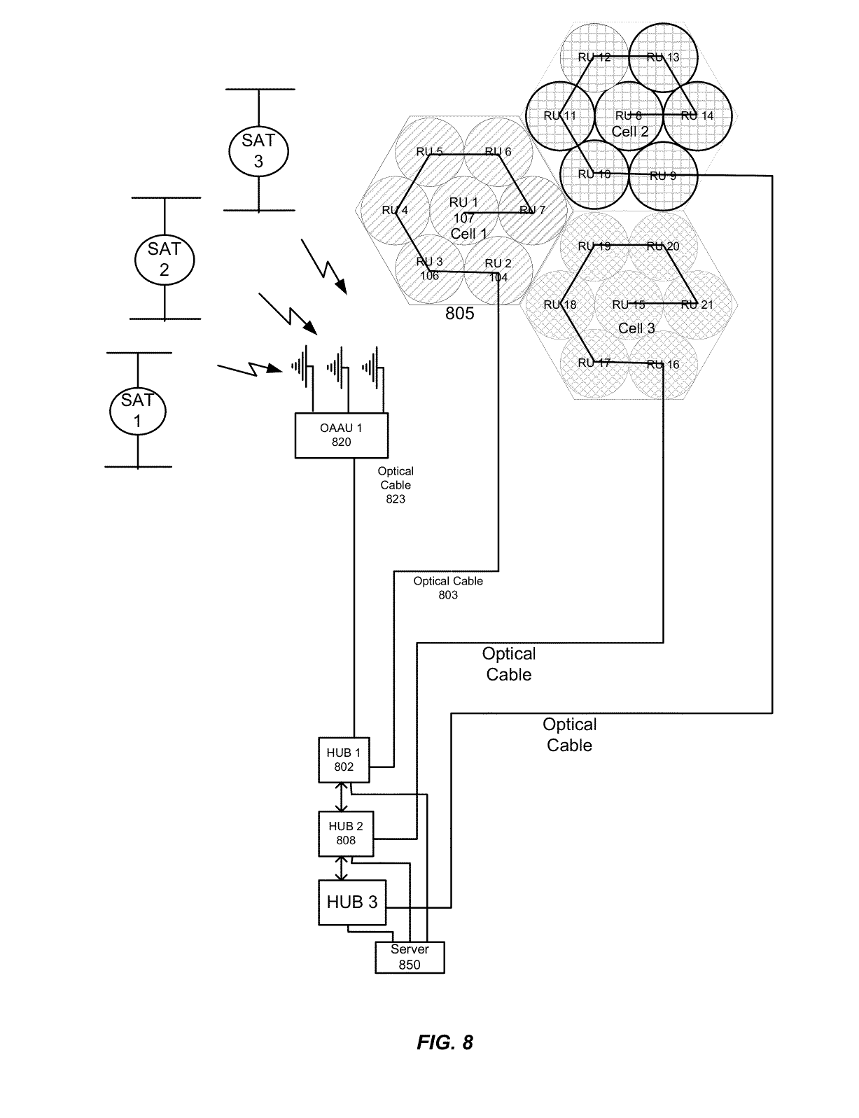

As shown in FIG. 8, the individual GPS signals from Satellites SAT 1, SAT 3 and SAT 4 are transported to a single OAAU with multiple directional antennas. FIG. 8 demonstrates how three independent Satellites, each Satellite communicating with an independent RF receiver in the OAAU (820). The OAAU (820) multiplexes the independent GPS signals to the DAS network as shown in FIG. 8.

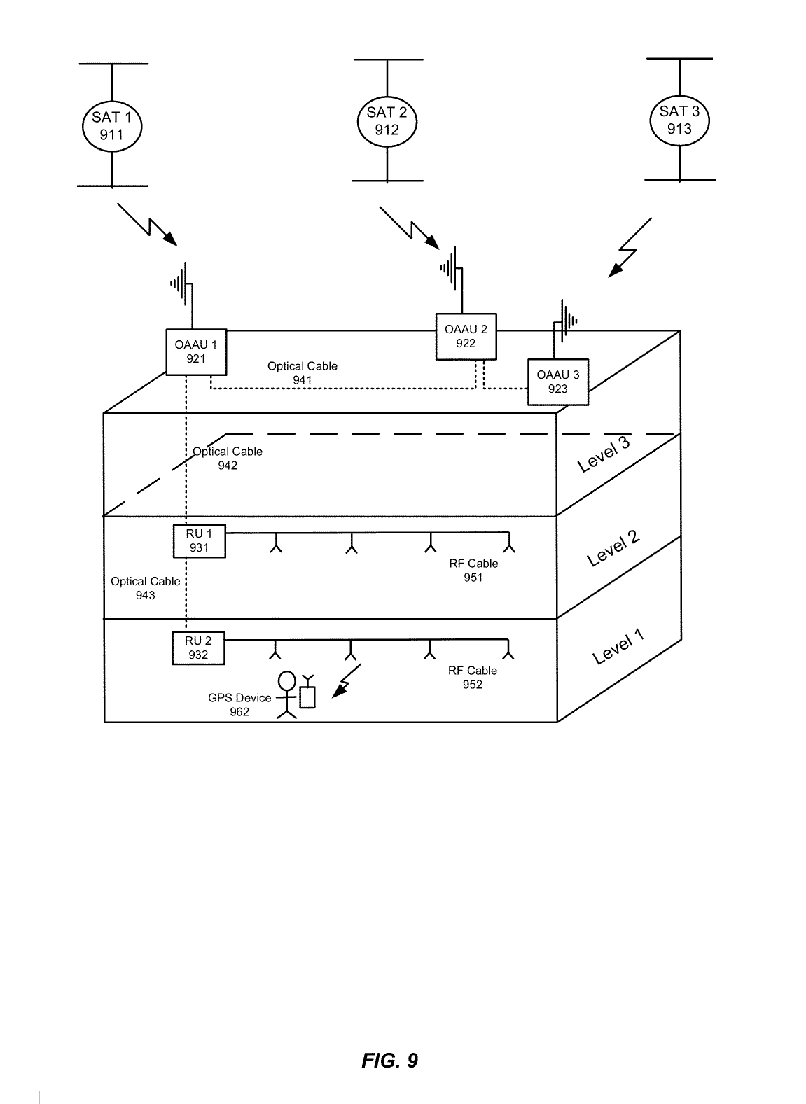

FIG. 9 shows an embodiment of the system used in a three level building. The Off-Air Access Units are located on the roof of the building and in line of sight of the Satellites. Directional antennas are used at the OAAUs in order to limit the number of Satellite GPS signals captured by each OAAU. The objective is to separate the Satellite GPS signals at each OAAU. The GPS signals are multiplexed on the optical fiber (941), (942) and transported to RU 1 (931) and RU 2 (932). The GPS signals are de-multiplexed at each RU and combined to create the position at the respective RU. The signals are broadcast through the RF antennas connected via RF cables to the RU. GPS Device (962) receives the signal broadcast from RU 2 (932) that identifies its position.

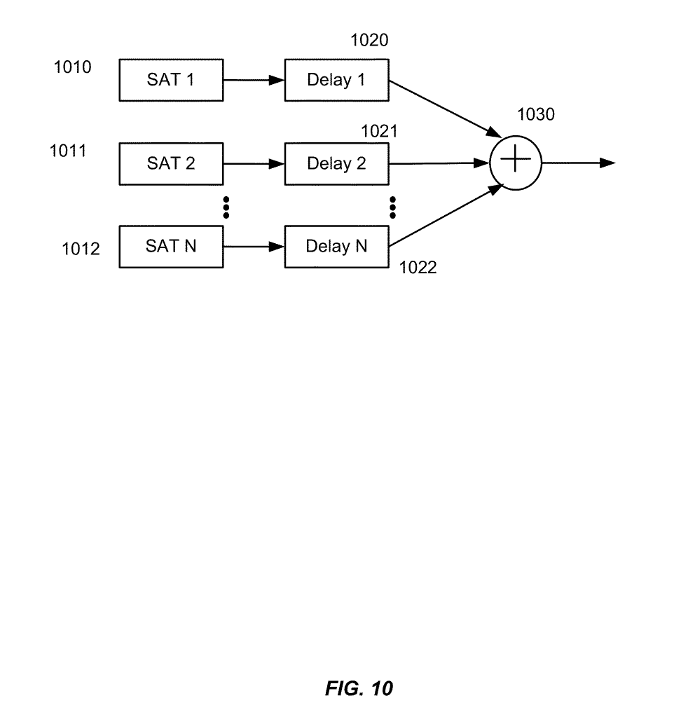

As shown in FIG. 10, the GPS Satellite signals are time delayed and summed in order to simulate the position of the RU. Each RU transmits the GPS position at the respective RU. The accuracy of the positional information at the users GPS device is a function of the proximity to the RU.

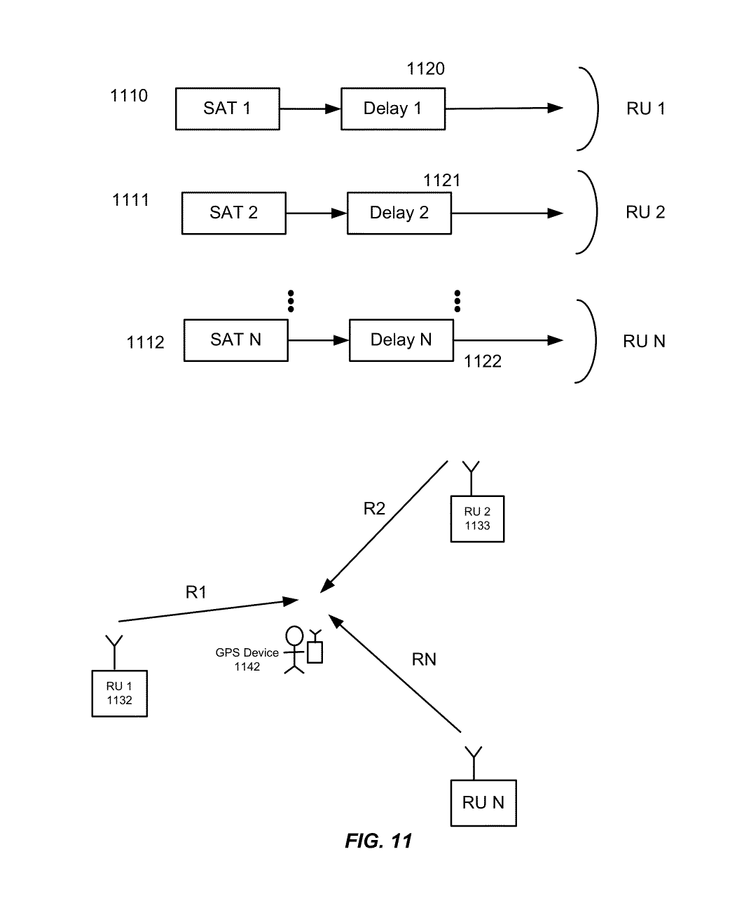

As shown in FIG. 11, the GPS Satellite signal at each RU time delays and transmits one or more of the respective GPS signals. This embodiment enables triangulation at the users GPS device by replicating the Satellite signals indoors.

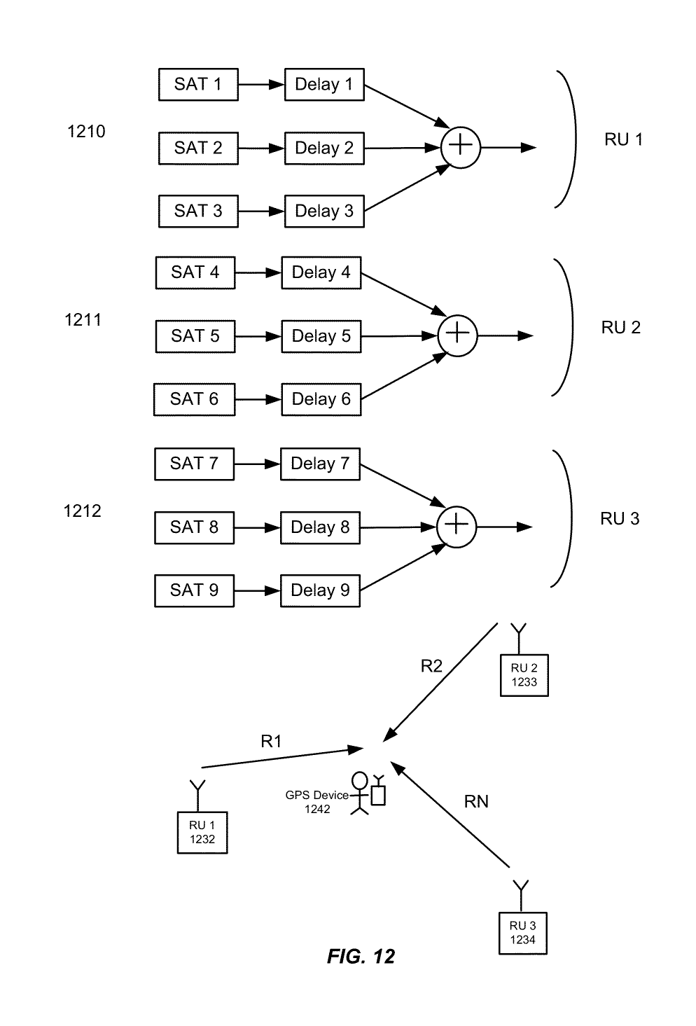

As shown in FIG. 12, the GPS Satellite signals are time delayed and summed at each RU. Each OAAU focuses on a distinct set of satellites. In this embodiment, 3 distinct satellite GPS signals are received at each of the OAAU and there are 3 OAAUs. Each RU transmits a unique set of Satellite GPS signals. This embodiment enables triangulation at the users GPS device by providing 3 unique GPS locations at the 3 RUs. The users GPS device will average the 3 GPS positions to obtain a more accurate position of the users location.

The position of a GPS receiver is determined by knowing its latitude, longitude and height. 4 measurements are required in order to determine the latitude, longitude, height and eliminate the receiver clock error. The GPS receiver has embedded software that has an algebraic model that describes the geometrical position. For each measurement an equation of the distance to the satellite, p, can be written that is a function of the satellite position (x,y,z), the GPS receiver position (X,Y,Z) and the clock error. For simplicity, the clock error has been removed from each equation below, since it is common to all equations.

p₁ₖ=\sqrt{(X−x₁+Δ₁ₖ)²+(Y−y₁+Δ₂ₖ)²+(Z−z₁+Δ₃ₖ)²}

p₂ₖ=\sqrt{(X−x₂+Δ₁ₖ)²+(Y−y₂+Δ₂ₖ)²+(Z−z₂+Δ₃ₖ)³}

p₃ₖ=\sqrt{(X−x₃+Δ₁ₖ)²+(Y−y₃+Δ₂ₖ)²+(Z−z₃+Δ₃ₖ)²}

p_{Nk}=\sqrt{(X−x_{N}+Δ₁ₖ)²+(Y−y_{N}+Δ₂ₖ)²+(Z−z_{N}+Δ₃ₖ)²}

where (X,Y,Z) is the position of the OAAU and (x_{N},y_{N},z_{N}) is the position of Satellite N. and (Δ₁ₖ,Δ₂ₖ,Δ₃ₖ) are the calculated positional offsets for RU k. The position of RU k is at (X+Δ₁ₖ,Y+Δ₂ₖ,Z+Δ₃ₖ).

The set of 4 or more equations must be solved simultaneously to obtain the values for the OAAU position (X,Y,Z). The Cartesian coordinates can be converted to latitude, longitude, and height in any geodetic datum. In general, a procedure known as the Newton-Raphson iteration is used. In this procedure, each of the equations is expanded into a polynomial based on a initial guesses of the OAAU position. Iteratively the 4 equations are solved simultaneously. If either one of the height, latitude or longitude is known then only 3 equations are necessary to resolve for the OAAU position.

The calculated positional offsets, Δ's , for each RU can be obtain from the blueprints of the venue and the location of the RU in the venue. The positional offsets are converted into time delays by dividing by the speed of light. The time delays are applied to signals (x₁, y₁, z₁) as shown in FIG. 10. The resultant signal is transmitted at the RU and subsequently received by the GPS device.

In some embodiments, the HUB is connected to a host unit/server, whereas the OAAU does not connect to a host unit/server. In these embodiments, parameter changes for the OAAU are received from a HUB, with the central unit that updates and reconfigures the OAAU being part of the HUB, which can be connected to the host unit/server. Embodiments of the present invention are not limited to these embodiments, which are described only for explanatory purposes.

It is also understood that the examples and embodiments described herein are for illustrative purposes only and that various modifications or changes in light thereof will be suggested to persons skilled in the art and are to be included within the spirit and purview of this application and scope of the appended claims.

Table 1 is a glossary of terms used herein, including acronyms, which may be applicable to various embodiments of the present invention.

### Table 1

### Glossary of Terms

ACLR Adjacent Channel Leakage Ratio
ACPR Adjacent Channel Power Ratio
ADC Analog to Digital Converter
AQDM Analog Quadrature Demodulator
AQM Analog Quadrature Modulator
AQDMC Analog Quadrature Demodulator Corrector
AQMC Analog Quadrature Modulator Corrector
BPF Bandpass Filter
CDMA Code Division Multiple Access
CFR Crest Factor Reduction
DAC Digital to Analog Converter
DET Detector
DHMPA Digital Hybrid Mode Power Amplifier
DDC Digital Down Converter
DNC Down Converter
DPA Doherty Power Amplifier
DQDM Digital Quadrature Demodulator
DQM Digital Quadrature Modulator
DSP Digital Signal Processing
DUC Digital Up Converter
EER Envelope Elimination and Restoration
EF Envelope Following
ET Envelope Tracking
EVM Error Vector Magnitude
FFLPA Feedforward Linear Power Amplifier
FIR Finite Impulse Response
FPGA Field-Programmable Gate Array
GSM Global System for Mobile communications
I-Q In-phase/Quadrature
IF Intermediate Frequency
LINC Linear Amplification using Nonlinear Components
LO Local Oscillator
LPF Low Pass Filter
MCPA Multi-Carrier Power Amplifier
MDS Multi-Directional Search
OFDM Orthogonal Frequency Division Multiplexing
PA Power Amplifier
PAPR Peak-to-Average Power Ratio
PD Digital Baseband Predistortion
PLL Phase Locked Loop
QAM Quadrature Amplitude Modulation
QPSK Quadrature Phase Shift Keying
RF Radio Frequency
RRH Remote Radio Head
RRU Remote Radio Head Unit
SAW Surface Acoustic Wave Filter
UMTS Universal Mobile Telecommunications System
UPC Up Converter
WCDMA Wideband Code Division Multiple Access
WLAN Wireless Local Area Network

What is claimed is:

1. A system for indoor localization using GPS signals in a Distributed Antenna System, the system comprising:
a plurality of Off-Air Access Units (OAAUs), each of the plurality of OAAUs operable to receive a GPS signal from at least one of a plurality of GPS satellites and operable to route signals optically to one or more local HUBs;
a plurality of remote units (RUs) located at Remote locations, wherein the plurality of RUs are operable to receive signals from one or more of the plurality of local HUBs; and
a delay unit operable to delay GPS satellite signal to provide indoor localization at each of the plurality of RUs.

2. The system of claim 1 wherein the delay unit includes an algorithm to delay each individual GPS satellite signal.

3. The system of claim 1 wherein the plurality of local HUBs are coupled via at least one of a Ethernet cable, Optical Fiber, or Wireless Link.

4. The system of claim 1 wherein the plurality of OAAUs are connected to a plurality of HUBs via at least one of Ethernet cable, Optical Fiber, RF Cable or Wireless Link.

5. The system of claim 1 wherein the OAAUs are Multiple Input Off-Air Access Units.

6. A system for indoor localization using GPS signals in a Distributed Antenna System, the system comprising:
a plurality of Off-Air Access Units (OAAUs), each of the plurality of OAAUs:
being connected together via a daisy chain configuration;
receiving a GPS signal from at least one of a plurality of GPS satellites; and
being operable to route signals optically to one or more HUBs;
a plurality of remote units (RUs) located at one or more Remote locations, wherein the plurality of RUs are operable to receive signals from a plurality of local HUBs; and
a delay block operable to delay the GPS signal.

7. The system of claim 6 wherein the delay block includes an algorithm operable to delay each individual GPS satellite signal for providing indoor localization at each of the plurality of RUs.

8. The system of claim 6 wherein the plurality of Off-Air Access Units (OAAUs) are coupled via at least one of Ethernet cable, Optical Fiber, RF Cable or Wireless Link.

9. A system for indoor localization using GPS signals in a Distributed Antenna System, the system comprising:
a plurality of Off-Air Access Units (OAAUs), receiving a GPS signal from at least one of a plurality of GPS satellites, and operable to route signals optically to one or more HUBs;
a plurality of remote units (RUs) located at one or more Remote locations, wherein the plurality of RUs are operable to receive signals from one or more of a plurality of local HUBs;
a de-multiplexer to extract one of the GPS satellite signals and time delay it at each of the plurality of RUs; and
an algorithm for determining the delay at each of the plurality of RUs to provide indoor localization.
